(19) United States
(12) Patent Application Publication
(10) Pub. No.: US 2021/0258141 A1
(43) Pub. Date: Aug. 19, 2021

(54) METHOD FOR RECOGNIZING EXPRESSION OF OPINION CAPABLE OF ENSURING ANONYMITY AND PREVENTING SYBIL ATTACKS, METHOD FOR REGISTERING THAT STORES USER?S IDENTIFICATION INFORMATION, AND METHOD FOR AUTHENTICATING THE USER

(71) Applicant: Korea Smart Authentication Corp., Seoul (KR)

(72) Inventors: Kibong MOON, Seoul (KR); Joonkoo KANG, Seoul (KR); Hawon HAN, Seoul (KR)

(21) Appl. No.: 17/306,089

(22) Filed: May 3, 2021

Related U.S. Application Data
(63) Continuation of application No. PCT/KR2019/010614, filed on Aug. 21, 2019.

(30) Foreign Application Priority Data
Nov. 8, 2018 (KR) 10-2018-0136592

(51) Int. Cl. H04L 9/00; H04L 9/32; H04L 9/06; G06F 7/58

(52) U.S. Cl. CPC H04L 9/008; H04L 9/3213; G06F 7/588; H04L 9/0643; H04L 9/3297

(57) ABSTRACT

The present disclosure relates to a method for registering an anonymous digital identity of a user with an identification information storage module in an environment including a user terminal, an account module, and the identification information storage module. The user terminal and the account module generate a first identification ID, a first token, a second random value, a second encryption value, a second value, and a first validation value through mutual communication. On the basis of the information, the identification information storage module generates a third hash value, a second token, an eighth value, and a second validation value through mutual communication with the user terminal. The account module validates the first token, the second hash value, and the first and second validation values, and registers the anonymous identity with the identification information storage module.

### CROSS-REFERENCE TO RELATED APPLICATION

This application is a Continuation of International Application No. PCT/KR2019/010614, filed on Aug. 21, 2019, which claims priority to Korean Application No. 10-2018-0136592, filed on Nov. 8, 2018. Both applications are incorporated herein by reference in their entireties.

### TECHINCAL FILED

The present disclosure relates to a method for recognizing online expression of opinion in the block chain environment. More specifically, the present disclosure relates to the method which guarantees anonymity and prevents Sybil Attack. Further, the present disclosure relates to a method for registering a module which stores a user's identification information, which is carried out before the recognition and the authentication of a person who provides an opinion.

### BACKGROUND

Recently, it frequently occurs that a person provides an opinion in online environment and a recipient recognizes the opinion. Electronic vote is the representative example of that case. Further, opinion regarding online deal and contract, opinion in online debate, reply to online contents and the like are the examples of that case.

Electronic vote is carried out by an electronic terminal that is capable of electronic arithmetic operation and data processing, with no need to visit a voting place. However, despite low cost, convenience, and scalability, the electronic vote has not been widely introduced because integrity cannot be guaranteed due to risks of hacking, insider manipulation, and distorted expression of opinion due to coercion.

Block chain technology can prevent the manipulation and hacking in the online expression of opinion such as the electronic vote. However, reliability of block chain is based on the transparency that everyone can see the records in the block chain. Thus, the identity of the person who expresses an opinion can be disclosed in the block chain and the privacy issue can arise in such an environment. Infinite public keys and the corresponding private keys for a person can be generated to hide the connectivity between the person's online activity and the person. However, such a case is vulnerable to Sybil Attack that one person generates numerous IDs and expresses its opinion with the numerous IDs to mislead online opinion expression, thereby violating the equality of online expression.

In order to prevent Sybil Attack, PII (Personally Identifiable Information) should be collected and the uniqueness of a person should be guaranteed. In the prior arts, online expression of opinion should be associated with PII, thereby compromising a person's privacy and an anonymity and limiting free expression of opinion. However, homomorphic encryption technology can guarantee the uniqueness of the user and anonymity.

Such an invention is disclosed by Korean Patent No. 1833323, the patentee of which is the applicant of the present application.

### SUMMARY

The object of the present disclosure is to provide a method for recognizing online expression of opinion, the security of which is improved compared with the above patent.

A computer-implemented method of registering a user's anonymous digital identity in a repository module of the present disclosure is carried out in an environment including a user terminal, an account module and the repository module. The method comprises a first step of receiving, by the account module, a request for registering the account module along with a first encryption value (Re_) which is a homomorphic encryption value of a first random value (Re), from the user terminal; a second step of generating, by the account module, a first ID (A_ID) and a second random value (Ra); a third step of generating, by the account module, a first token (p_token); a fourth step of carrying out, by the account module, a first arithmetic operation to the first ID (A_ID), the first encryption value (Re_), the second random value (Ra) and a first zero encryption value, to generate a second encryption value (AA_ID_) which is an encryption value of a second ID (AA_ID); a fifth step of carrying out, by the account module, hash to the second encryption value (AA_ID_) to generate a first hash value (h_AA_ID); a sixth step of carrying out, by the account module, hash to a first value including the first token (p_token) and the first hash value (h_AA_ID) to generate a second hash value (h_enroll); a seventh step of carrying out, by the account module, electronic signature to a second value including the first hash value (h_AA_ID) and the second hash value (h_enroll) to generate a first validity verification value; an eight step of transmitting, by the account module, the first ID (A_ID), the first token (p_token), the second random value (Ra), the second encryption value (AA_ID_), the second value, and the first validity verification value to the user terminal; a ninth step of receiving, by the repository module, a biometric information, the second encryption value (AA_ID_), the second value, the first validity verification value, and the second zero encryption value (Ze′_) from the user terminal; a tenth step of carrying out, by the repository module, a second arithmetic operation to the second encryption value (AA_ID_) and a third value (Cr) to generate a third encryption value which is a homomorphic encryption value of a third ID (R_ID); an eleventh step of carrying out, by the repository module, a third arithmetic operation to obtain a fourth encryption value (tag1_) which is a homomorphic encryption value of a first tag value, the third arithmetic operation being an operation where a value obtained by multiplying the third encryption value (R_ID_) and a 3-1 random value (R1), a 3-2 random value (R2), and a value obtained by multiplying a 3-3 random value (R3) and the second zero encryption value (Ze′_) are subtracted or added to one another; a twelfth step of storing, by the repository module, the biometric information, the 3-1 random value (R1), the 3-2 random value (R2), the first session ID (rs_id), the second value, and the first validity verification value; a thirteenth step of transmitting, by the repository module, the first session ID (rs_id), a third value (Cr), a fourth value (G), a fifth value (P), the third encryption value (R_ID_) and the fourth encryption value (tag_) to the user terminal; a fourteenth step of receiving, by the repository module, the first session ID (rs_id), a sixth value (R_ID$) which is obtained by carrying an out arithmetic operation to the third ID (R_ID), and a seventh value (tag1$) which is obtained by carrying out an arithmetic operation to the first tag value, from the user terminal; a fifteenth step of verifying, by the repository module, the seventh value; a sixteenth step of carrying out, by the repository module, hash to the sixth value to generate a third hash value (r_id); a seventeenth step of storing, by the repository module, the third has value (r_id) and the biometric information; an eighteenth step of generating, by the repository module, a second token; a nineteenth step of carrying out, by the repository module, electronic signature to an eighth value including the first validity verification value to generate a second validity verification value; a twentieth step of transmitting, by the repository module, the third hash value, the second token (r_token), the second value, the eighth value and the second validity verification value, to the user terminal; a twenty-first step of receiving, by the account module, a request for registering the repository module along with the first ID (A_ID), the first token (p_token), the second value, the eighth value and the second validity verification value, from the user terminal; and a twenty-second step of verifying, by the account module, the first token (p_token), the second hash value (h_enroll), the first validity verification value and the second validity verification value to complete the registration.

The first value and the second value can further include time information (data a) of the account module.

The eighth value can further includes time information (data r) of the repository module.

A computer-implemented method of authenticating the user of the present disclosure is carried out after the anonymous digital identity is registered according to the above method. The method comprises: a 1-1 step of receiving, by the account module, the first ID (A_ID), the first token (p_token) and the first zero encryption value (Ze_) from the user terminal; a 1-2 step of generating, by the account module, a second session ID (as_id) for the authentication; a 1-3 step of carrying out, by the account module, the first arithmetic operation to the first ID (A_ID), the first encryption value (Re_), the second random value (Ra) and the first zero encryption value to generate a second encryption value (AA_ID_) which is an encryption value of the second ID (AA_ID); a 1-4 step of carrying out, by the account module, hash to the second encryption value (AA_ID_) to generate a first hash value (h_AA_ID); a 1-5 step of carrying out, by the account module, hash to a value including the second session ID (as_id) and the first hash value (h_AA_ID) to generate a fourth hash value (h_auth); a 1-6 step of carrying out, by the account module, electronic signature to a ninth value including the first hash value (h_AA_ID) and the fourth hash value (h_auth) to generate a third validity verification value; a 1-7 step of transmitting, by the account module, the second session ID (as_id), the second encryption value (AA_ID_), the ninth value and the third validity verification value, to the user terminal; a 1-8 step of receiving, by the repository module, a request for verification of the third hash value along with the third hash value (r_id), the second token (r_token), the second encryption value (AA_ID_), the ninth value, the third validity verification value and the second zero encryption value (Ze′_) from the user terminal; a 1-9 step of carrying out, by the repository module, the second arithmetic operation to the second encryption value (AA_ID_) and the third value (Cr) to generate a third encryption value which is a homomorphic encryption value of the third ID (R_ID); a 1-10 step of carrying out, by the repository module, the third arithmetic operation to obtain a fourth encryption value (tag_) which is a homomorphic encryption value of the first tag value, the third arithmetic operation being an operation where a value obtained by multiplying the third encryption value (R_ID) and a 3-1 random value (R1), a 3-2 random value (R2) and a value obtained by multiplying a 3-3 random value (R3) and the second zero encryption value (Ze′_) are subtracted or added to one another; a 1-11 step of transmitting, by the repository module, the first session ID (rs_id), the third value (Cr), the fourth value (G), the fifth value (P), the third encryption value (R_ID_J and the fourth encryption value (tag_), to the user terminal; a 1-12 step of receiving, by the repository module, the first session ID (rs_id), a sixth value (R_ID$) which is obtained by carrying out an arithmetic operation to the third ID (R_ID) and a seventh value (tag1$) which is obtained by carrying out an arithmetic operation to the first tag value, from the user terminal; a 1-13 step of verifying, by the repository module, the seventh value; a 1-14 step of carrying out, by the repository module, electronic signature to a tenth value including the third validity verification value to generate a fourth validity verification value; a 1-15 step of transmitting, by the repository module, the ninth value, the tenth value, and the fourth validity verification value, to the user terminal; a 1-16 step of receiving, by the account module, the first ID (A_ID), the second session ID (as_id), the ninth value, the tenth value and the fourth validity verification value, from the user terminal; and a 1-17 step of transmitting, by the account module, a third token to the user terminal if the verification of the first ID (A_ID), the fourth hash value (h_auth), the third validity verification value and the fourth validity verification value is successful.

The value to be hashed in the 1-5 step can further include time information (date_a) of the account module; and the ninth value further includes time information (data_a) of the account module.

The tenth value can further include time information (data_r) of the repository module.

The first arithmetic operation can be “the first encryption value (Re_)*the second random value (Ra)+the first ID (A_ID)+a 2-1 random value (Rc)*the first zero encryption value (Ze_)+noise.”

The second arithmetic operation can be “the second encryption value (AA_ID)*the third value (Cr).”

The third arithmetic operation can be “the 3-1 random value (R1)*the third encryption value (R_ID_)+the 3-2 random value (R2)+the 3-3 random value (R3)*the second zero encryption value (Ze′_).”

The sixth value can be G^{R_ID} (mod P); the seventh value can be G^{tag}1 (mod P); and the fifteenth step can be carried out by comparing the seventh value with R_ID$^{R1}*G^{R2} (mod P).

A computer-implemented method of recognizing online express of opinion of the present disclosure is carried out in the environment comprising a user terminal, an account module, a repository module and a node module of block chain after the authentication according to the above method of the present disclosure. The method comprises a 2-1 step of receiving, by the node module, a subject identification information (v_id) from the user terminal; a 2-2 step of transmitting, by the node module, the fourth value (G), the fifth value (P) and the eleventh value (Cv) to the user terminal; a 2-3 step of carrying out, by the user terminal, a fourth arithmetic operation to the first random value (Re), the second random value (Ra), the first ID (A_ID), and the eleventh value (Cv) to generate a user's identification information (BS); a 2-4 step of carrying out, by the user terminal, an arithmetic operation to the user's identification information (BS) to generate a twelfth value (BS$); a 2-5 step of carrying out, by the user terminal, hash to the twelfth value to generate a fifth hash value (bs); a 2-6 step of receiving, by the user terminal, an opinion value (voting) from the user; a 2-7 step of encrypting, by the user terminal, a sixth hash value which is a hash value of a thirteenth value including the subject identification information (v_id), the fifth hash value and the opinion value (voting) to generate a fifth encryption value; a 2-8 step of generating, by the user terminal, a first zero encryption value (Ze_); a 2-9 step of receiving, by the account module, a request for the second ID (AA_ID) and blind signature along with the first ID (A_ID), the third token, the first zero encryption value (Ze_) and the fifth encryption value, from the user terminal; a 2-10 step of carrying out, by the account module, hash to the second encryption value (AA_ID_) to generate a first hash value (h_AA_ID); a 2-11 step of carrying out, by the account module, blind signature to the fifth encryption value; a 2-12 step of carrying out, by the account module, electronic signature to a fourteenth value including the first hash value (h_AA_ID) to generate a fifth validity verification value; a 2-13 step of transmitting, by the account module, the second encryption value (AA_ID_), the blind signature value, the fourteenth value, and the fifth validity verification value, to the user terminal; a 2-14 step of obtaining, by the user terminal, a sixth validity verification value which is a validity verification value of the thirteenth value, from the blind signature value; a 2-15 step of generating, by the user terminal, a second zero encryption value (Ze′); a 2-16 step of receiving, by the node module, a request for the user's identification information (BS) along with the subject identification information (v_id), the second encryption value (AA_ID_), the second zero encryption value (Ze′_), the fourteenth value and the fifth validity verification value, from the user terminal; a 2-17 step of carrying out, by the node module, a fifth arithmetic operation to the second encryption value (AA_ID_) and the eleventh value (Cv) to generate a sixth encryption value (BS_); a 2-18 step of transmitting, by the node module, a request for a second tag value (tag2) along with the sixth encryption value (BS_) and the second zero encryption value (Ze′), to the repository module; a 2-19 step of of carrying out, by the repository module, a sixth arithmetic operation to obtain a seventh encryption value (tag2_) which is a homomorphic encryption value of the second tag value (tag2), the sixth arithmetic operation being an operation where a value obtained by multiplying the sixth encryption value (BS_) and a 3-1 random value (R1), a 3-2 random value (R2) and a value obtained by multiplying a 3-3 random value (R3) and the second zero encryption value (Ze′_) are subtracted or added to one another; a 2-20 step of receiving, by the node module, a seventh hash value which is a hash value of the 3-1 random value (R1) and the 3-2 random value (R2), the session ID (vs_id) and the seventh encryption value (tag2_), from the repository module; a 2-21 step of transmitting, by the node module, the session ID (vs_id), the sixth encryption value (BS_), the seventh encryption value (tag2_) and the seventh hash value, to the user terminal; a 2-22 step of receiving, by the node module, the session ID (vs_id), a fifteenth value (BS$) which is a value obtained by carrying out an arithmetic operation to the user's identification information, a sixteenth value which is a value obtained by carrying out an arithmetic operation to the second tag value, the seventh hash value, the subject identification information (v_id), the fifth hash value (bs), the opinion value (voting) and the sixth validity verification value, from the user terminal; a 2-23 step of transmitting, by the node module, a request for verification of the fifteenth value (BS$) along with the fifteenth value (BS$), the sixteenth value (tag2$), the session ID (vs id), the fourth value (G) and the fifth value (P), to the repository module; a 2-24 step of verifying, by the node module, the 3-1 random value (R1) and the 3-2 random value (R2) by comparing the seventh value with the hash value of the 3-1 random value (R1) and the 3-2 random value (R2) received from the repository module; and a 2-25 step of storing, by the node module, the opinion value (voting), the subject identification value (v_id), the fifth hash value (bs) and the sixth validity verification value if the verification of the value (BS$), the fifth hash value (bs) and the sixth validity verification value is successful.

The fourteenth value can further include time information of the account module.

The fourth arithmetic operation can be “[the first random value (Re)*the second random value (Ra)+the first ID (A_ID)]*the eleventh value (Cv).”

The value (BS$) derived from the subject identification information (BS) can be the fourth value^{BS} (mod P).

The fifth arithmetic operation can be “the second encryption value (AA_ID_)*the eleventh value (Cv).”

The sixth arithmetic operation can be “R1*BS_+R2+R3*Ze′.

The value (tag2$) derived from the second tag value can be G^{tag2} (mod P).

According to the present disclosure, a user's eligibility verification is guaranteed; a node which uploads opinion to block chain and an authentication server are separated from each other, thereby increasing security level; and the connection between the opinion and the user who expresses the opinion cannot be leaked due to the blind signature. Further, the zero encryption value is used, to mask the other encryption values, thereby increasing the security level. Further, the authentication server carries out four basic arithmetic operations without carrying out hash operation, thereby decreasing the load of the server.

### BRIEF DESCRIPTION OF THE DRAWINGS

The present disclosure will be more fully understood from the following detailed description taken in conjunction with the accompanying drawings.

FIGS. 1 to 4 show flow charts of the method for registering anonymous digital identity in the module which stores a user's identification information.

FIGS. 5 to 8 show flow charts of the method for authenticating a user according to the present disclosure.

FIGS. 9 to 12 show flow charts of the method for recognizing online expression of opinion according to the present disclosure.

FIG. 13 shows a block diagram of the unlimited exemplary device, module or unit which carries out the present disclosure.

It should be understood that the above-referenced drawings are not necessarily to scale, presenting a somewhat simplified representation of various preferred features illustrative of the basic principles of the disclosure. The specific design features of the present disclosure will be determined in part by the particular intended application and use environment.

### DETAILED DESCRIPTION

Hereinafter, the present disclosure will be described in detail with reference to the accompanying drawings.

In this specification, transmitting/receiving of information (data) can be carried out with encryption/decryption if necessary. It should be understood that transmitting/receiving described in this specification can be carried out with encryption/decryption although not specifically mentioned. Further, transmitting (forwarding) to B from A or receiving by A from B include the process via an additional medium, not limited to direct transmitting or receiving. The order of each step should be understood in a non-limited manner unless a preceding step must be performed logically and temporally before a following step. That is, except for the exceptional cases as described above, although a process described as a following step is preceded by a process described as a preceding step, it does not affect the nature of the present disclosure, and the scope of rights should be defined regardless of the order of the steps. In addition, in this specification, “A or B” is defined not only as selectively referring to either A or B, but also as including both A and B. In addition, in this specification, the term “comprise” has a meaning of further including other components in addition to the components listed.

The term “module” means a logical combination of a universal hardware and a software carrying out required function.

In this specification, the essential elements for the present disclosure will be described and the non-essential elements may not be described. However, the scope of the present disclosure should not be limited to the invention including only the described components. Further, the invention which includes additional element or does not have non-essential elements can be within the scope of the present disclosure.

The present disclosure can be carried out by an electronic arithmetic device such as a computer. The arithmetic operation and calculation which will be described hereinafter can be carried out by the known computing codes for the operation or calculation, or the computing codes which is appropriately conceived for the present disclosure.

The term “value” described in this specification is defined as being universal value which includes vector, matrix, tensor and polynomial as well as scholar value.

In this specification, the encryption or hash of a specific value includes the encryption or hash of a value derived from the specific value. The value to be encrypted or hashed can be derived by carrying out arithmetic operation to the specific value. Further, “hash” is defined by having a universal meaning of one-way function in the specification.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprise” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. The term “coupled” denotes a physical relationship between two components whereby the components are either directly connected to one another or indirectly connected via one or more intermediary components. Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

The terms “first,” “second,” or the like are herein used to distinguishably refer to same or similar elements, and they may not infer an order or a plurality.

The method according to the present disclosure can be carried out by an electronic arithmetic device such as a computer, tablet, mobile phone, portable computing device, stationary computing device, etc. Additionally, it is understood that one or more various methods, or aspects thereof, may be executed by at least one processor. The processor may be implemented on a computer, tablet, mobile device, portable computing device, etc. A memory configured to store program instructions may also be implemented in the device(s), in which case the processor is specifically programmed to execute the stored program instructions to perform one or more processes, which are described further below. Moreover, it is understood that the below information, methods, etc. may be executed by a computer, tablet, mobile device, portable computing device, etc. including the processor, in conjunction with one or more additional components, as described in detail below. Furthermore, control logic may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a remote fashion, e.g., by a telematics server or a Controller Area Network (CAN).

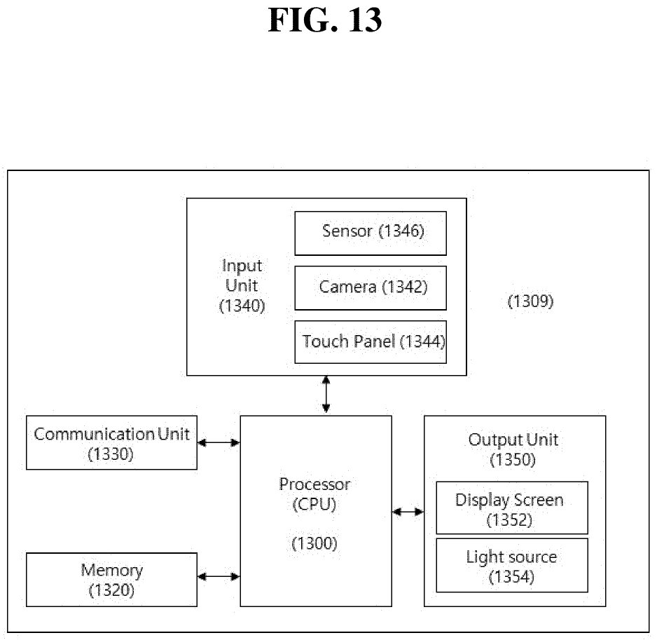

The present disclosure is carried out by a various electronic device. FIG. 13 illustrates an example diagrammatic view of an exemplary device architecture according to embodiments of the present disclosure. As shown in FIG. 13, a device (1309) may contain multiple components, including, but not limited to, a processor (e.g., central processing unit (CPU; 1300), a memory (1320), a wired or wireless communication unit (1330), one or more input units (1340), and one or more output units (1350). It should be noted that the architecture depicted in FIG. 13 is simplified and provided merely for demonstration purposes. The architecture of the device (1309) can be modified in any suitable manner as would be understood by a person having ordinary skill in the art, in accordance with the present claims. Moreover, the components of the device (1309) themselves may be modified in any suitable manner as would be understood by a person having ordinary skill in the art, in accordance with the present claims. Therefore, the device architecture depicted in FIG. 13 should be treated as exemplary only and should not be treated as limiting the scope of the present disclosure.

The processor (1300) is capable of controlling operation of the device (1309). More specifically, the processor (1300) may be operable to control and interact with multiple components installed in the device (1309), as shown in FIG. 13. For instance, the memory (1320) can store program instructions that are executable by the processor (1300) and data. The process described herein may be stored in the form of program instructions in the memory (1320) for execution by the processor (1300). The communication unit (1330) can allow the device (1309) to transmit data to and receive data from one or more external devices via a communication network. The input unit (1340) can enable the device (1309) to receive input of various types, such as audio/visual input, user input, data input, and the like. To this end, the input unit (1340) may be composed of multiple input devices for accepting input of various types, including, for instance, one or more cameras (1342) (i.e., an “image acquisition unit”), touch panel (1344), microphone (not shown), sensors (1346), keyboards, mice, one or more buttons or switches (not shown), and so forth. The term “image acquisition unit,” as used herein, may refer to the camera (1342), but is not limited thereto. The input devices included in the input (1340) may be manipulated by a user. The output unit (1350) can display information on the display screen (1352) for a user to view. The display screen (1352) can also be configured to accept one or more inputs, such as a user tapping or pressing the screen (1352), through a variety of mechanisms known in the art. The output unit (1350) may further include a light source (1354). The device (1309) is illustrated as a single component, but the device may also be composed of multiple, separate components that are connected together and interact with each other during use.

In this specification, “expression of opinion” means expression of user's opinion on a subject or issue such as electronic vote, online debate, reply to online contents and the like.

Further, the expression includes not only one expression of opinion on a subject or an issue but also a plurality of expressions on the same subject or the issue.

In the specification, “*_” means a homomorphic encryption value of *. The “encryption” in the specification means “homomorphic encryption” unless described otherwise. However, other kind of encryption scheme can be applied if it does not interfere with the essential elements of the present disclosure.

In the specification, “HE(*)” means the homomorphic encryption value of *.

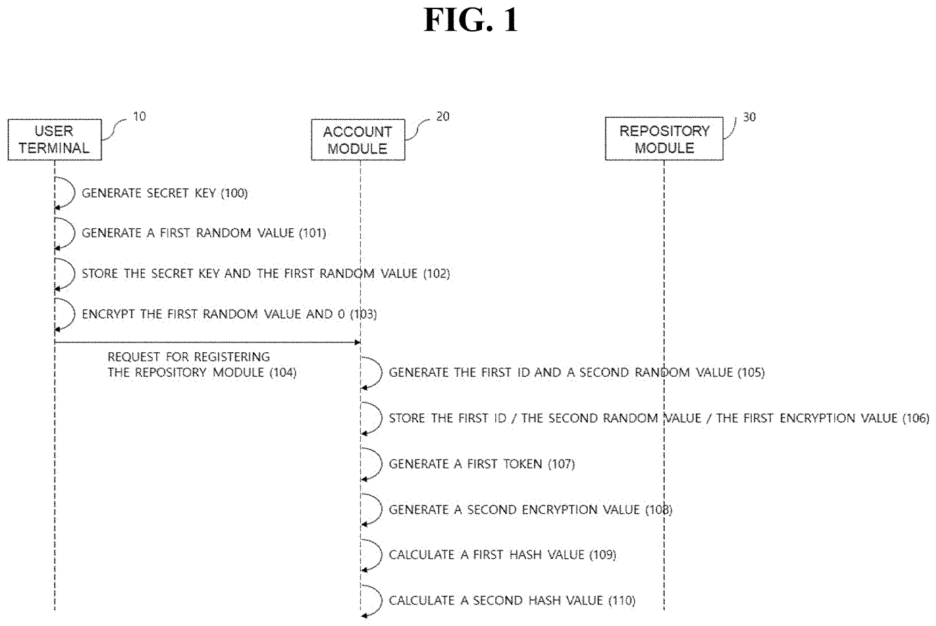

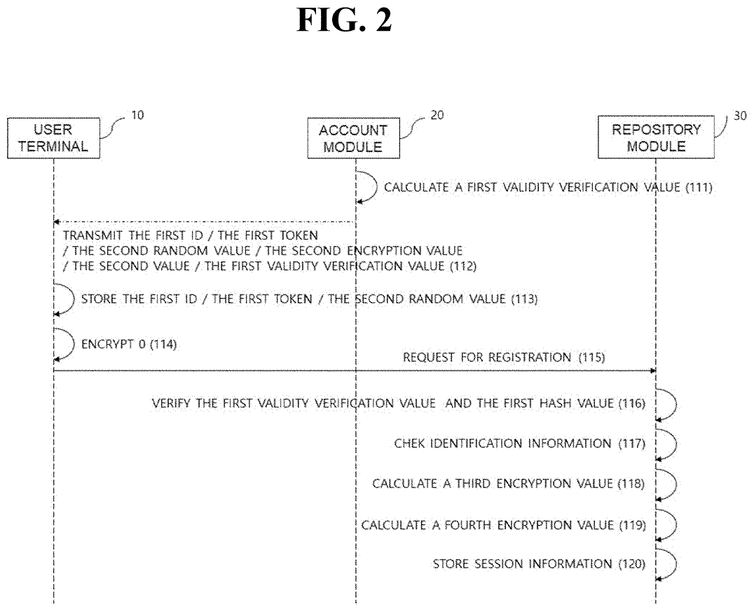

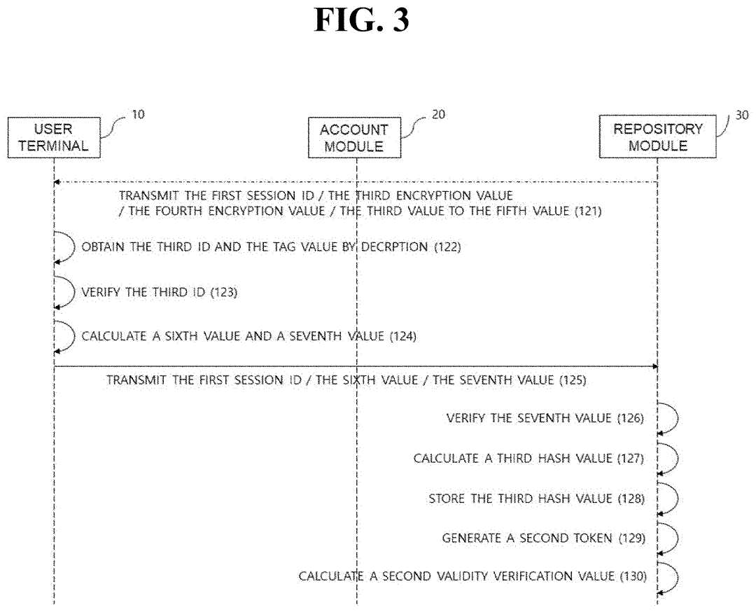

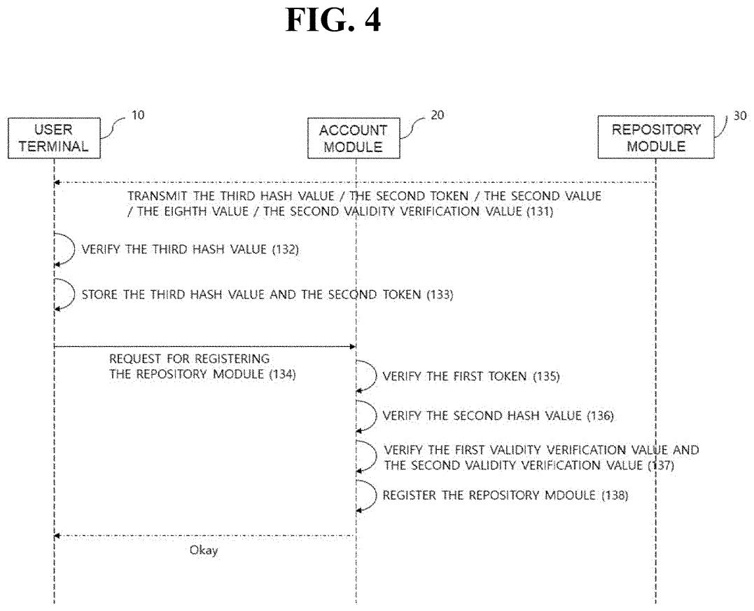

FIG. 1 shows a flow chart of the method for establishing anonymous digital identity according to the present disclosure. In this specification, “anonymous digital identity” means an object which cannot identify who he/she is in the off-line environment but can define a unique identity in digital environment. The digital identity includes a predetermined credential.

The method of registering identity verification information according to the present disclosure can be carried out in the environment comprising a user terminal (10), an account module (20), and a repository (30) for storing identity verification information. The user terminal (10) can be any kind of electronic device which can carry out electronic operation and data communication, for example, a smartphone, a PC, a tablet PC and the like.

Each account module (20) has a unique identification information and is generated for each user. The account module (20) can be included in a block chain. A user can carry out an activity or work in online environment through the account module (20) which is uniquely provided to the user. The account module (20) does not have a user information and just has a token which verifies an anonymous digital identity as described hereinafter. Various tokens for verifying digital identity can be provided to a user, thereby enabling the user to use various online services with the token.

The repository module (30) can act as a role of a server. The repository module (30) does not possess personal information of a user as described hereinafter. The repository module (30) can have the information that can determine whether a user is a registered anonymous user, but does not match the information with other information that can specifically identify the user.

In the step (100), the user terminal (10) generates a secret key (sk). If the public key encryption scheme is applied, a public key is also generated.

The user terminal (10) generates a first random value (Re) in the step (101), and stores the secret key (sk) and the first random value (Re) in the step (102).

The user terminal (10) encrypts the first random value (Re) and “0” to generate a first encryption value (Re_) and a first zero encryption value (Ze_) respectively in the step (103).

The user terminal (10) transmits the first encryption value (Re_) and the first zero encryption value (Ze_) to the account module (20) and requests start of registration process in the step (104).

The account module (20) generates a first ID (A_ID) and a second random value (Ra) in the step (105) and stores the two values together with the first encryption value (Re_) in the step (106). The first ID (A_ID) can be uniquely provided to an account module for each user.

The account module (20) generates a first token (p_token) in the step (107). The account module (20) generates a second encryption value (AA_ID_) in the step (108). The second encryption value (AA_ID_) can be calculated by a first arithmetic operation as follows:

AA_ID_=f1(Ra, Re_, A_ID, Rc, Ze _) =Ra*Re_+A_ID+Rc*Ze_=HE(f1(Ra, Re, A_ID, Rc, Ze_)=HE(f1(Ra, Re, A_ID)

The 2-1 random value (Rc) is a random value generated by the account module (20).

The decrypted value of Ze_ is “0.” Thus, Ze_ does not do any role in the arithmetic operation but the equation including Ze_ can make other value unknown by masking effects.

Small noise that does not affect the arithmetic operation can be added or subtracted in the equation, thereby masking the real values.

In the step (109), the account module (20) carries out one-way function operation to the second encryption value (AA_ID_) and then calculates a first hash value (h_AA_ID).

The account module (20) calculates a second hash value (h_enroll) in the step (110). The second hash value (h_enroll) is calculated as follows:

h_enroll=Hash (the first value)

The first value is defined by a value including the first token (p_token) and the first hash value (h_AA_ID). The first value can further include time information (date_a) of the account module.

The account module (20) calculates a first validity verification value in the step (111).

Although the term of “validity verification value” or “electronic signature” is described in this specification, any alternative way can be used as long as it can determine whether information is forged or altered. Validity verification value can include conventional electronic signature value.

The first validity verification value is calculated as follows:

Sign _1=Sign [the second value]

The second value is defined as a value including the first hash value (h_AA_ID) and the second hash value (h_enroll). The second value can further include time information (date_a) of the account module.

The account module (20) transmits the first ID (A_ID), the first token (p_token), the second random value (Ra), the second encryption value (AA_ID_), the second value and the first validity verification value to the user terminal (10) in the step (112).

The user terminal (10) stores the first ID (A_ID), the first token (p_token) and the second random value (Ra) in the step (113). The stored values are used in verification of a third ID (R_ID) which will be described in the below.

The user terminal (10) which received the first ID (A_ID) from the account module (20) requests for the repository module (30) to register an anonymous identity. It is assumed that the repository module (30) has a third value (Cr), a fourth value (G) and a fifth value (P) which are predetermined constants. The fifth value (P) can be a large prime number.

The user terminal (10) encrypts “0” to generate a second zero encryption value (Ze′_) in the step (114).

In the step (115), the user terminal (10) transmits biometric information, the second encryption value (AA_ID_), the second value, the first validity verification value and the second zero encryption value (Ze′_) to the repository module (30) and then requests registration of anonymous identify.

The repository module (30) verifies the first validity verification value and the first hash value (h_AA_ID) in the step (116). The verification of the first hash value (h_AA_ID) is carried out by determining whether the hash value of the second encryption value (AA_ID_) received in the step (115) is identical to the first hash value (h_AA_ID) included in the second value received in the step (115).

The repository module (30) checks the biometric information received in the step (115). That is, the repository module (30) checks whether there is a previously registered user by comparing the received biometric information with the registered biometric information. If there is not a previously registered user, the next step is carried out.

The repository module (30) calculates a third encryption value (R_ID_) in the step (118). The third encryption value (R_ID_) is a homomorphic encryption value of the third ID (R_ID) and can be calculated by a second arithmetic operation as follows:

R_ID_=f2(AA_ID_, Cr)=f2[(Ra*Re_+A_ID+Rc*Ze_), Cr)]=f2[HE(f1(Ra, Re, A_ID), Cr)=HE[f2{f1(Ra, Re, A_ID)), Cr}]

That is, R_ID can be “f2{f1(Ra, Re, A_ID)), Cr}.”

The above equation can be used when the user terminal verifies the third ID.

f2(AA_ID, Cr) can be AA_ID_*Cr.

The repository module (30) calculates a fourth encryption value (tag1_) which is a homomorphic encryption value of a first tag value (tag1) by the following a third arithmetic operation in the step (119):

tag1_=R1*R_ID+R2+R3*Ze′_

The third equation is defined as an equation where a value obtained by multiplying the third encryption value (R_ID_) and a 3-1 random value (R1), the 3-2 random value (R2), and a value obtained by multiplying a 3-3 random value (R3) and the second zero encryption value (Ze′_) are added or subtracted from one another. The 3-1 random value (R1) to the 3-3 random value (R3) can be generated by the repository module (30).

The repository module (30) stores the first session regarding the registration process in the step (120). The stored information can include a first session ID (rs_id), the 3-1 random value (R1), the 3-2 random value (R2), the biometric information, the second value, and the first validity verification value.

The repository value (30) transmits the first session ID (rs_id), the third encryption value (R_ID_), the fourth encryption value (tag1_), and the third value to the fifth value, to the user terminal in the step (121).

The user terminal decrypts the third encryption value (R_ID_) and the fourth encryption value (tag1_) to obtain the third ID (R_ID) and the first tag value (tag1) in the step (122).

The repository module (30) can share the secret key which is generated by the user terminal in the step (100). In the public key encryption, the repository module (30) can carry out encryption by the public key which is generated by the user terminal (10).

The user terminal (10) verifies the third ID (R_ID) in the step (123). The verification is carried out as follows:

R_ID=?f1(Ra, Re, A_ID)*Cr=(Ra*Re+A_ID)*Cr

The user terminal (10) calculates a sixth value (R_ID$) and a seventh value (tag1$) in the step (124). The sixth value (R_ID$) is obtained by carrying out an arithmetic operation to the third ID (R_ID). The seventh value is obtained by carrying out an arithmetic operation to the first tag value (tag1).

For example, the sixth value and the seventh value can be obtained as follows:

R_ID$=G^{R_ID} (mod P)

tag1$=G^{tag1} (mod P)

The user terminal (10) transmits the first session ID (rs_id), the sixth value (R_ID$) and the seventh value (tag1$) to the repository module (30) in the step (125).

The repository module (30) verifies the seventh value (tag1$) in the step (126).

The verification of the seventh value (tag1$) is carried out as follows:

tag1$=? (R_ID$^{R1}*G^{R2}) (mod P)

If the verification is successful, the third hash value (r_id) is calculated by hashing the sixth value (R_ID$) in the step (127) and is stored together with the biometric information in the step (128).

The repository module (30) generates a second token (r token) in the step (129). In the step (130), a second validity verification value is calculated by carrying out electronic signature to an eighth value including the first validity verification value. The eighth value can include time information (date_r) of the repository module (30). In that case, the eight value is set to be valid only during a predetermined time.

The repository module (30) transmits the third hash value (r_id), the second token (r_token), the second value, the eighth value, and the second validity verification value, to the user terminal (10) in the step (131).

The user terminal (10) compares the sixth value (R_ID$) calculated in the step (124) with the third hash value (r_id) received in the step (131) to verify the third hash value (r_id) in the step (132).

If the verification is successful, the user terminal (10) stores the third hash value (r_id) and the second token (r_token) in the step (133).

The user terminal (10) requests for the account module (20) to register the repository module in the step (134). This is for requesting that the account module (20) register that a user's anonymous digital identity is registered in the repository module. In the request, the first ID (A_ID), the first token (p_token), the second value, the eight value and the second validity verification value are transmitted.

The account module (20) verifies the first token (p_token) in the step (135) and verifies the second hash value (h_enroll) in the step (136). The verification of the first token (p_token) is carried out by comparing it with the first token generated in the step (107). The verification of the second hash value (h_enroll) is carried out by comparing the second hash value (h_enroll) received in the step (134) with the hash value of the first value.

The account module (20) verifies the first validity verification value and the second validity verification value in the step (137). The verification of the first validity verification value is carried out to prove that the received second value is normal data signed by the account module (20). The verification of the second validity verification is carried out to prove that the eighth value is normal data signed by the repository module (30).

If the verifications are successful, the account module (20) registers that the user's anonymous digital identity is registered in the repository module (30) and transmits the registration fact to the user terminal (10). The first ID (A_ID) is associated with the registration. The first ID (A_ID) is shared only between the user terminal and the account module (20) while the repository module (30) does not have the ID, thereby improving the security level.

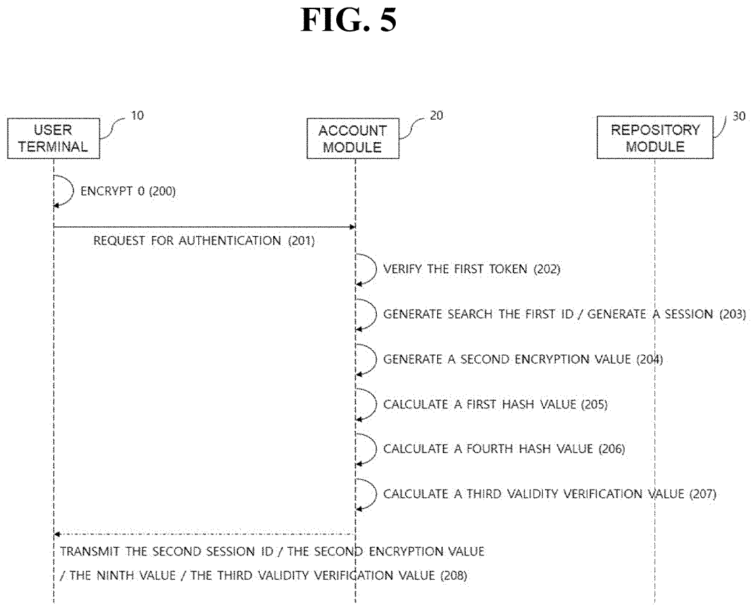

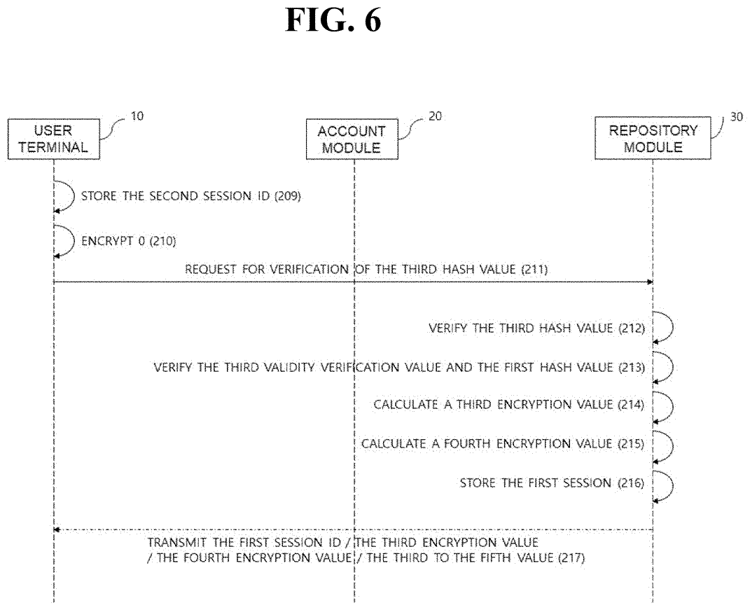

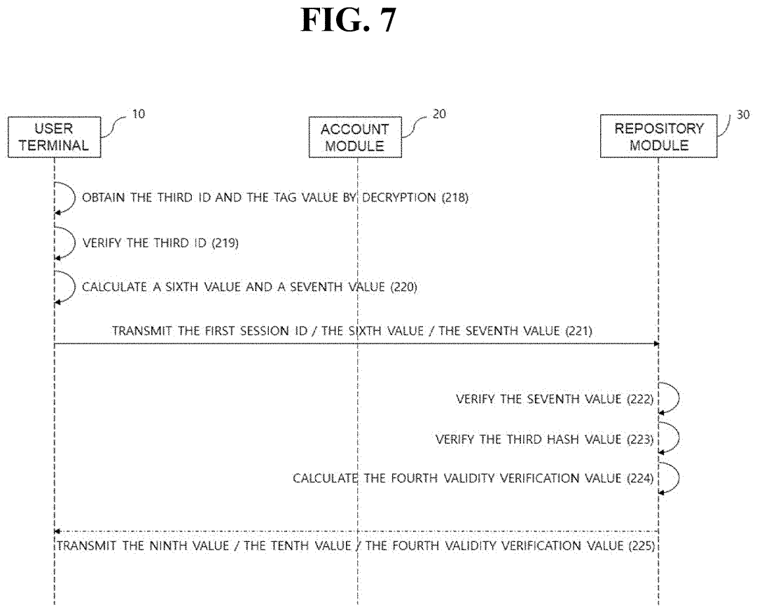

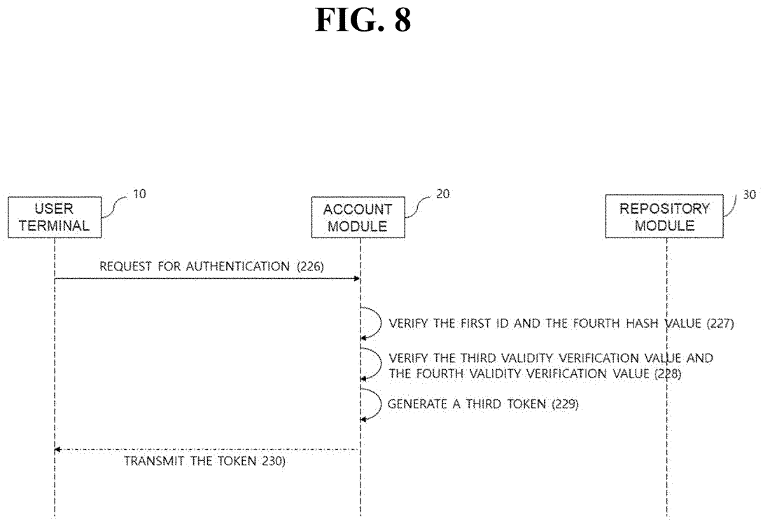

FIGS. 5 to 8 show the flow charts of the method for pre-authenticating before the online expression of opinion.

Prior to carrying out the steps of FIGS. 5 to 8, a user can perform identity verification. For example, the user performs fingerprint authentication or iris authentication before the steps of FIGS. 5 to 8.

The user terminal (10) calculates the first zero encryption value (Ze_) by encrypting “0” in the step (200). The user terminal (10) requests for the account module (20) to start authentication process in the step (201). In the step (201), the first ID (A_ID), the first token (p_token), and the first zero encryption value (Ze_) are transmitted to the account module (20).

In the step (202), the account module (20) verifies the first token (p_token) by comparing the first token received in the step (201) with the generated token in the step (107). The account module (20) checks whether the received first ID (A_ID) exists and generates authentication session ID (a second session ID; as id) in the step (203) if the first ID exists.

The account module (20) generates the second encryption value (AA_ID_) in the step (204) and generates the first hash value (h_AA_ID).

The second encryption value can be calculated by the same equation in the step (108) and the first hash value can be calculated by the same way in the step (109).

The account module (20) generates a fourth hash value (h_auth) as follows:

h_auth=Hash(as id, h_AA_ID)

The value to be hashed can include the time information of the account module.

The account module (20) calculates a third validity verification value by carrying out electronic signature to a ninth value including the first hash value (h_AA_ID) and the fourth hash value (h_auth) in the step (207).

The ninth value can include the time information of the account module.

The account module transmits the second session ID (as_id), the second encryption value (AA_ID_), the ninth value, and the third validity verification value, to the user terminal (10) in the step (208).

The user terminal (10) stores the second session ID (as_id) in the step (209) and calculates the second zero encryption value (Ze′_) by encrypting “0” in the step (210).

The user terminal (10) requests for the repository module (30) to verify the third hash value (r_id) in the step (211). In the step (211), the third hash value (r_id), the second token (r_token), the second encryption value (AA_ID), the ninth value, the third validity verification value and the second zero encryption value (Ze′_) are transmitted.

The repository module (30) carries out the verification by determining whether the third hash value (r_id) is matched with the second token (r_token) in the step (212).

The repository module (30) verifies the third validity verification value and the first hash value (h_AA_ID) included in the ninth value in the step (213).

The repository module (30) calculates a third encryption value (R_ID_) in the step (214) and generates the fourth encryption value (tag1_) in the step (215). The processes are the same as the steps (118, 119).

The repository module (30) stores the first session ID (rs_id), the third hash value (r_id), the 3-1 random value (R1), the 3-2 random value (R2), the ninth value, and the third validity verification value in the step (216).

The repository module (30) transmits the first session ID (rs_id), the third encryption value (R_ID_), the fourth encryption value (tag1_), and third to fifth values (Cr, G, P) to the user terminal (120) in the step (217).

The steps (218) to the steps (222) correspond to the steps (122) to the steps (126) respectively.

In the step (223), the repository module (30) verifies the third hash value (r_id) by comparing a value obtained by hashing the sixth value (R_ID$) received in the step (223) with the third hash value (r_id).

The repository module (30) calculates the fourth validity verification value by carrying out electronic signature to a tenth value including the third validity verification value in the step (224). The tenth value can include time information of the repository module.

The repository module (30) transmits the ninth value, the tenth value and the fourth validity verification value to the user terminal (10) in the step (225).

The user terminal (10) requests authentication to the account module (20) in the step (226). In the request, the first ID (A_ID), the second session ID (as_id), the ninth value, the tenth value and the fourth validity verification value are transmitted to the account module.

The account module (20) verifies the second session ID (as_id) and the fourth hash value (h_auth) in the step (227). In the step (228), the third validity verification value included in the tenth value and the fourth validity verification value are verified. If the verification is successful, a third token is generated in the step (229) and is transmitted to the user terminal to complete the pre-authentication.

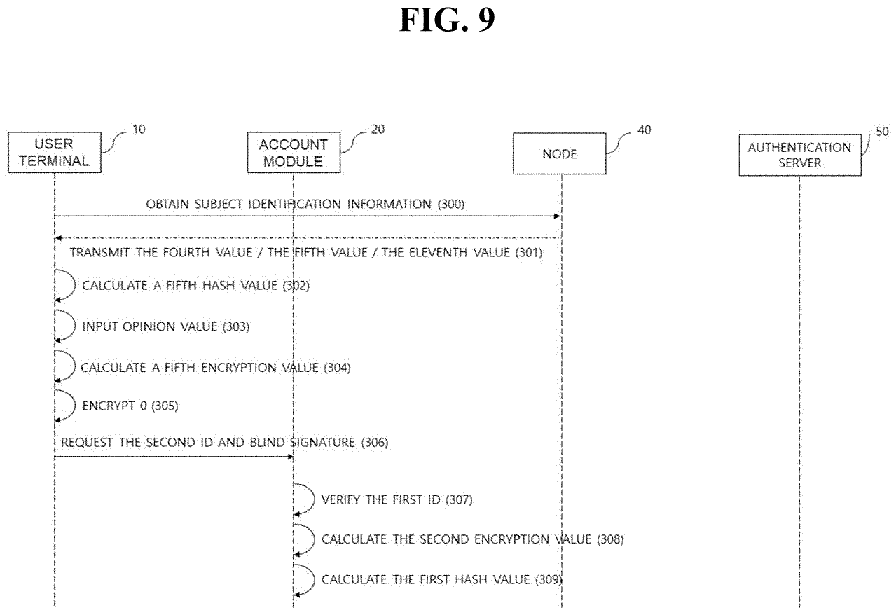

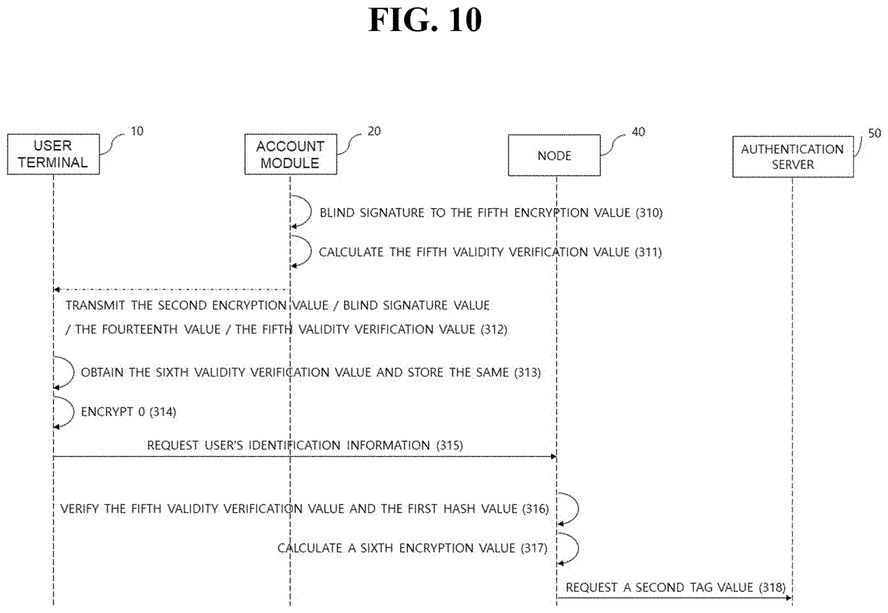

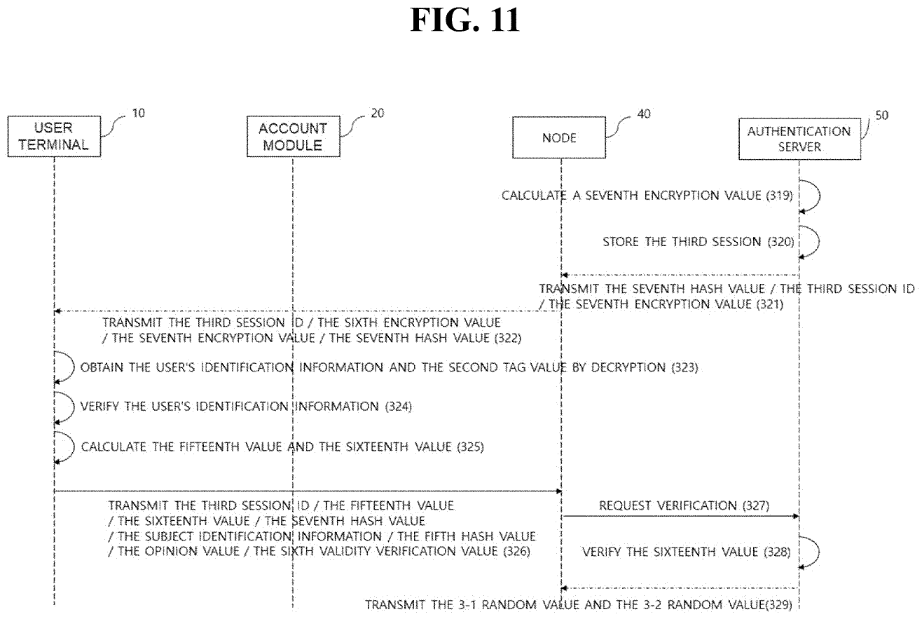

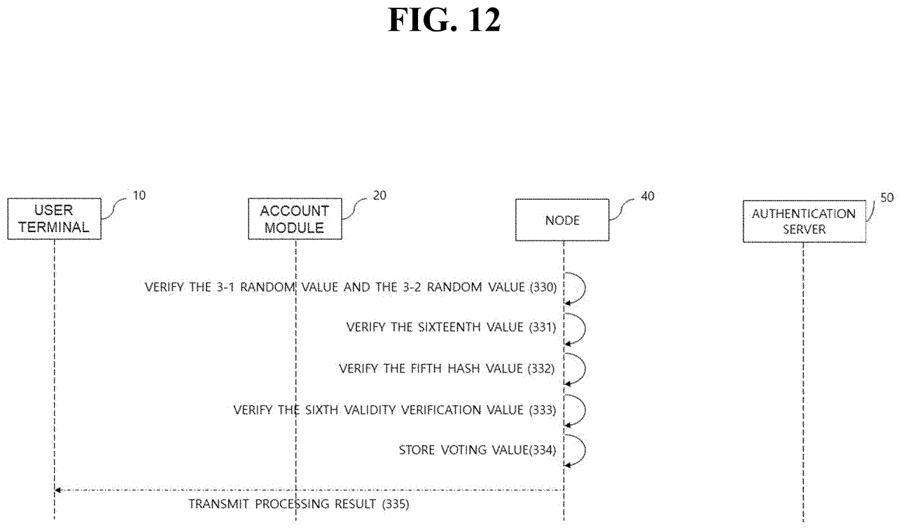

FIGS. 9 to 12 show flow charts of method for recognizing the online expression of opinion.

The method for recognizing the expression of opinion of the present disclosure can be carried out the environment comprising the user terminal (10), the account module (20), a node (40), and an authenticating server (50). The node (40) uploads the online expression of opinion to a block chain. The node (40) has the fourth value (G), the fifth value (P) and an eleventh value (Cv).

In the step (300), a user provides the node (40) through the user terminal (10) with the subject identification information (v_id) which specifies the subject the user intends to express his/her opinion. The node (40) transmits the fourth value (G), the fifth value (P) and the eleventh value (Cv) to the user terminal (10).

The user terminal (10) calculates the fifth hash value (bs) in the step (302). The fifth hash value (bs) can be calculated as follows:

BS=f4(Ra, Re, A_ID, Cv)=(Ra*Re+A_ID)*Cv

BS is the user's identification information for the expression of the user's opinion.

BS$=G^{BS} (mod P)

BS$ is defined as a twelfth value which is a value obtained by carrying out a predetermined arithmetic operation to the user's identification information.

bs=Hash(BS$)

The user inputs the opinion value (voting) to the user terminal in the step (303).

The user terminal (10) calculates a fifth encryption value as follows in the step (304):

The fifth encryption value =Enc(hash(v id, bs, voting))

The thirteenth value is defined as a value including the subject identification information (v_id), the fifth hash value (bs) and the opinion value (voting). The sixth hash value is defined as a value obtained by carrying out hash to the thirteenth value. The fifth encryption value is a value obtained by encrypting the sixth hash value.

The user terminal (10) calculates the first zero encryption value (Ze_) by encrypting “0” in the step (305).

The user terminal (10) requests the second ID (AA_ID) and blind signature to the account module (20) in the step (306). In the step, the first ID (A_ID), the third token, the first zero encryption value (Ze_) and the fifth encryption value are transmitted to the account module (20).

The account module (20) verifies the first ID (A_ID) in the step (307) and calculates the second encryption value (AA_ID_) in the step (308). The second encryption value (AA_ID_) can be calculated in the same way of the step (108) and the step (204).

The account module (20) carries out hash to the second encryption value (AA_ID_) to obtain the first hash value (h_AA_ID) in the step (309).

The account module (20) carries out blind signature to the fifth encryption value in the step (310). The account module (20) carries out electronic signature to the fourteenth value including the first hash value (h_AA_ID) to obtain a fifth validity verification value in the step (311). The fourteenth value can include time information (date_a) of the account module.

The account module (20) transmits the second encryption value (AA_ID_), the blind signature value, the fourteenth value and fifth validity verification value to the user terminal in the step (312).

The user terminal (10) obtains a sixth validity verification value from the blind signature value and stores the sixth validity verification value. The sixth validity verification value can be the electronic signature value of the thirteenth value.

The user terminal (10) encrypts “0” to obtain the second zero encryption value (Ze′_) in the step (314).

The user terminal (10) requests the user's identification information (BS) to the node (40) in the step (315). In the step, the subject identification information (v id), the second encryption value (AA_ID_), the second zero encryption value (Ze′_), the fourteenth value and the fifth validity verification value are transmitted to the node (40).

The node (40) verifies the fifth validity verification value and the first hash value (h_AA_ID) in the step (316). The node (40) calculates the sixth encryption value (BS_) in the step (317). The sixth encryption value (BS_) which is a homomorphic encryption value of the user's identification information (BS), is obtained by multiplying the second encryption value (AA_ID_) and the eleventh value (Cv).

The node (40) requests the second tag value (tag2) to the authentication server (50) in the step (318). In the step, the sixth encryption value (BS_) and the second zero encryption value (Ze′_) are transmitted.

The authentication server (50) calculates a seventh encryption value (tag2_) in the step (319) as follows:

tag2_=R1*BS_+R2+R3*Ze′_

The above equation is different from that of the calculation of the fourth encryption value in that the sixth encryption value (BS_) is multiplied to the 3-1 random value(R1).

The authentication server (50) stores the third session ID relating to the recognition process of expression of opinion in the step (320). The stored information can include the third session ID (vs_id), the 3-1 random value (R1) and the 3-2 random value (R2).

The authentication server (50) transmits the seventh hash value which is obtained by hashing the 3-1 random value (R1) and the 3-2 random value (R2), the third session ID (vs_id) and the seventh encryption value (tag2_) to the node (40) in the step (321).

The node (40) transmits the third session ID (vs_id), the sixth encryption value (BS_), the seventh encryption value (tag2_) and the seventh hash value to the user terminal (10) in the step (322).

The user terminal (10) decrypts the sixth encryption value (BS_) and the seventh encryption value (tag2_) to obtain the user's identification information (BS) and the second tag value (tag2) in the step (323).

The user terminal (10) verifies the user's identification information (BS) in the step (324). The verification is carried out by comparing the user's identification information (BS) received in the step (323) with the value calculated in the step (302).

The user terminal (10) calculates the fifteenth value and the sixteenth value in the step (325).

The fifteenth value is a value (BS$) which is obtained by carrying out a predetermined arithmetic operation to the user's identification information (BS). The sixteenth value is a value (tag2$) which is obtained by carrying out a predetermined arithmetic operation to the second tag value (tag2). BS$ and tag2$ can be calculated as follows:

BS$=G^{BS} (mod P)

tag2$=G^{tag2} (mod P)

The user terminal (10) transmits the third session ID (vs_id), the fifteenth value (BS$), the sixteenth value (tag2$), the seventh hash value, the subject identification information (v_id), the fifth hash value (bs), the opinion value, and the sixth validity verification value to the node (40) in the step (326).

The node (40) requests for the authentication server (50) to verify the fifteenth value (BS$) and the sixteenth value (tag2$) in the step (327). In the request, the third session ID (vs_id), the fifteenth value (BS$), the sixteenth value (tag2$), the fourth value (G), and the fifth value (P) are transmitted to the authentication server (50).

The authentication server (50) verifies the sixteenth value (tag2$) as follows:

tag2$=? (BS$^{R1}*G^{R2}) (mod P)

If the verification is successful, the authentication server (50) transmits the 3-1 random value (R1) and the 3-2 random value (R2) to the node (40). In the step (330), the node (40) verifies the 3-1 random value (R1) and the 3-2 random value (R2) by comparing the seventh hash value received in the step (321) with a value obtained by hashing the received 3-1 random value (R1) and the received 3-2 random value (R2).

The node (40) verifies the sixteenth value (tag2$) in the step (331) as follows:

tag2$=?BS$^{R1}*G^{R2} (mod P)

In the step (332), the node (40) compares the fifth hash value (bs) received in the step (326) with the value obtained by hashing the fifteenth value (BS$) to verify the fifth hash value.

In the step (333), the node (40) verifies the sixth validity verification value received in the step (326). If every verification is successful, in the step (334), the node (40) records the voting value associating with v_id, bs and the sixth validity verification value in the block chain and transmits the fact to the user terminal.

According to the present disclosure, the security level is enhanced by separating the node which uploads the voting result to the block chain from the authentication server. Further, blind signature can prevent the voting result from being disclosed. Further, the method of the present disclosure uses a zero encryption value to mask the other encryption value, thereby increasing security level. Further, the authentication serer carries out four basic arithmetic operations without carrying out hash operation, thereby decreasing the load of the authentication server.

Although the present disclosure has been described with reference to accompanying drawings, the scope of the present disclosure is determined by the claims described below and should not be interpreted as being restricted by the embodiments and/or drawings described above. It should be clearly understood that improvements, changes and modifications of the present disclosure disclosed in the claims and apparent to those skilled in the art also fall within the scope of the present disclosure.

What is claimed is:

1. A computer-implemented method of registering a user's anonymous digital identity in a repository module, which is carried out in an environment including a user terminal, an account module and the repository module, the method comprising:
a first step of receiving, by the account module, a request for registering the account module along with a first encryption value (Re_) which is a homomorphic encryption value of a first random value (Re), from the user terminal;
a second step of generating, by the account module, a first ID (A_ID) and a second random value (Ra);
a third step of generating, by the account module, a first token (p_token);
a fourth step of carrying out, by the account module, a first arithmetic operation to the first ID (A_ID), the first encryption value (Re_), the second random value (Ra) and a first zero encryption value, to generate a second encryption value (AA_ID_) which is an encryption value of a second ID (AA_ID);
a fifth step of carrying out, by the account module, hash to the second encryption value (AA_ID_) to generate a first hash value (h_AA_ID);
a sixth step of carrying out, by the account module, hash to a first value including the first token (p_token) and the first hash value (h_AA_ID) to generate a second hash value (h_enroll);
a seventh step of carrying out, by the account module, electronic signature to a second value including the first hash value (h_AA_ID) and the second hash value (h_enroll) to generate a first validity verification value;
an eight step of transmitting, by the account module, the first ID (A_ID), the first token (p_token), the second random value (Ra), the second encryption value (AA_ID_), the second value, and the first validity verification value to the user terminal;
a ninth step of receiving, by the repository module, a biometric information, the second encryption value (AA_ID_), the second value, the first validity verification value, and the second zero encryption value (Ze′_) from the user terminal;
a tenth step of carrying out, by the repository module, a second arithmetic operation to the second encryption value (AA_ID_) and a third value (Cr) to generate a third encryption value which is a homomorphic encryption value of a third ID (R_ID);
an eleventh step of carrying out, by the repository module, a third arithmetic operation to obtain a fourth encryption value (tag1_) which is a homomorphic encryption value of a first tag value, the third arithmetic operation being an operation where a value obtained by multiplying the third encryption value (R_ID_) and a 3-1 random value (R1), a 3-2 random value (R2), and a value obtained by multiplying a 3-3 random value (R3) and the second zero encryption value (Ze′_) are subtracted or added to one another;
a twelfth step of storing, by the repository module, the biometric information, the 3-1 random value (R1), the 3-2 random value (R2), the first session ID (rs_id), the second value, and the first validity verification value;
a thirteenth step of transmitting, by the repository module, the first session ID (rs_id), a third value (Cr), a fourth value (G), a fifth value (P), the third encryption value (R_ID_) and the fourth encryption value (tag_) to the user terminal;
a fourteenth step of receiving, by the repository module, the first session ID (rs_id), a sixth value (R_ID$) which is obtained by carrying an out arithmetic operation to the third ID (R_ID), and a seventh value (tag1$) which is obtained by carrying out an arithmetic operation to the first tag value, from the user terminal;
a fifteenth step of verifying, by the repository module, the seventh value;
a sixteenth step of carrying out, by the repository module, hash to the sixth value to generate a third hash value (r_id);
a seventeenth step of storing, by the repository module, the third has value (r_id) and the biometric information;
an eighteenth step of generating, by the repository module, a second token;
a nineteenth step of carrying out, by the repository module, electronic signature to an eighth value including the first validity verification value to generate a second validity verification value;
a twentieth step of transmitting, by the repository module, the third hash value, the second token (r_token), the second value, the eighth value and the second validity verification value, to the user terminal;
a twenty-first step of receiving, by the account module, a request for registering the repository module along with the first ID (A_ID), the first token (p_token), the second value, the eighth value and the second validity verification value, from the user terminal; and
a twenty-second step of verifying, by the account module, the first token (p_token), the second hash value (h_enroll), the first validity verification value and the second validity verification value to complete the registration.

2. The computer-implemented method of claim 1, wherein the first value and the second value further include time information (data_a) of the account module.

3. The computer-implemented method of claim 1, wherein the eighth value further includes time information (data_r) of the repository module.

4. The computer-implemented method of claim 1, wherein the first arithmetic operation is “the first encryption value (Re_)*the second random value (Ra)+the first ID (A_ID)+a 2-1 random value (Rc)*the first zero encryption value (Ze_)+noise.”

5. The computer-implemented method of claim 1, wherein the second arithmetic operation is “the second encryption value (AA_ID_)*the third value (Cr).”

6. The computer-implemented method of claim 5, wherein the third arithmetic operation is “the 3-1 random value (R1)*the third encryption value (R_ID_)+the 3-2 random value (R2)+the 3-3 random value (R3)*the second zero encryption value (Ze′_).”

7. The computer-implemented method of claim 6, wherein the sixth value is G^{R_ID} (mod P); the seventh value is G^{tag1} (mod P); and the fifteenth step is carried out by comparing the seventh value with R_ID$R1*G^{R2} (mod P).

8. A computer-implemented method of authenticating the user which is carried out after the anonymous digital identity is registered according to the method of claim 1, the method comprising:
a 1-1 step of receiving, by the account module, the first ID (A_ID), the first token (p_token) and the first zero encryption value (Ze_) from the user terminal;
a 1-2 step of generating, by the account module, a second session ID (as_id) for the authentication;
a 1-3 step of carrying out, by the account module, the first arithmetic operation to the first ID (A_ID), the first encryption value (Re_), the second random value (Ra) and the first zero encryption value to generate a second encryption value (AA_ID_) which is an encryption value of the second ID (AA_ID);
a 1-4 step of carrying out, by the account module, hash to the second encryption value (AA_ID_) to generate a first hash value (h_AA_ID).
a 1-5 step of carrying out, by the account module, hash to a value including the second session ID (as_id) and the first hash value (h_AA_ID) to generate a fourth hash value (h_auth);
a 1-6 step of carrying out, by the account module, electronic signature to a ninth value including the first hash value (h_AA_ID) and the fourth hash value (h_auth) to generate a third validity verification value;
a 1-7 step of transmitting, by the account module, the second session ID (as_id), the second encryption value (AA_ID_), the ninth value and the third validity verification value, to the user terminal;
a 1-8 step of receiving, by the repository module, a request for verification of the third hash value along with the third hash value (r_id), the second token (r_token), the second encryption value (AA_ID_), the ninth value, the third validity verification value and the second zero encryption value (Ze′_) from the user terminal;
a 1-9 step of carrying out, by the repository module, the second arithmetic operation to the second encryption value (AA_ID_) and the third value (Cr) to generate a third encryption value which is a homomorphic encryption value of the third ID (R_ID);
a 1-10 step of carrying out, by the repository module, the third arithmetic operation to obtain a fourth encryption value (tag_) which is a homomorphic encryption value of the first tag value, the third arithmetic operation being an operation where a value obtained by multiplying the third encryption value (R_ID_) and a 3-1 random value (R1), a 3-2 random value (R2) and a value obtained by multiplying a 3-3 random value (R3) and the second zero encryption value (Ze′_) are subtracted or added to one another;
a 1-11 step of transmitting, by the repository module, the first session ID (rs_id), the third value (Cr), the fourth value (G), the fifth value (P), the third encryption value (R_ID_) and the fourth encryption value (tag_), to the user terminal;
a 1-12 step of receiving, by the repository module, the first session ID (rs_id), a sixth value (R_ID$) which is obtained by carrying out an arithmetic operation to the third ID (R_ID) and a seventh value (tag1$) which is obtained by carrying out an arithmetic operation to the first tag value, from the user terminal;
a 1-13 step of verifying, by the repository module, the seventh value;
a 1-14 step of carrying out, by the repository module, electronic signature to a tenth value including the third validity verification value to generate a fourth validity verification value;
a 1-15 step of transmitting, by the repository module, the ninth value, the tenth value, and the fourth validity verification value, to the user terminal;
a 1-16 step of receiving, by the account module, the first ID (A_ID), the second session ID (as_id), the ninth value, the tenth value and the fourth validity verification value, from the user terminal; and
a 1-17 step of transmitting, by the account module, a third token to the user terminal if the verification of the first ID (A_ID), the fourth hash value (h_auth), the third validity verification value and the fourth validity verification value is successful.

9. The computer-implemented method of claim 8, wherein the value to be hashed in the 1-5 step further includes time information (date_ a) of the account module; and the ninth value further includes time information (data_a) of the account module.

10. The computer-implemented method of claim 8, wherein the tenth value further includes time information (data_r) of the repository module.

11. A computer-implemented method of recognizing online express of opinion which is carried out in the environment comprising a user terminal, an account module, a repository module and a node module of block chain after the authentication according to the method of claim 8, the method comprising:
a 2-1 step of receiving, by the node module, a subject identification information (v_id) from the user terminal;
a 2-2 step of transmitting, by the node module, the fourth value (G), the fifth value (P) and the eleventh value (Cv) to the user terminal;
a 2-3 step of carrying out, by the user terminal, a fourth arithmetic operation to the first random value (Re), the second random value (Ra), the first ID (A_ID), and the eleventh value (Cv) to generate a user's identification information (BS);
a 2-4 step of carrying out, by the user terminal, an arithmetic operation to the user's identification information (BS) to generate a twelfth value (BS$);
a 2-5 step of carrying out, by the user terminal, hash to the twelfth value to generate a fifth hash value (bs);
a 2-6 step of receiving, by the user terminal, an opinion value (voting) from the user;
a 2-7 step of encrypting, by the user terminal, a sixth hash value which is a hash value of a thirteenth value including the subject identification information (v_id), the fifth hash value and the opinion value (voting) to generate a fifth encryption value;
a 2-8 step of generating, by the user terminal, a first zero encryption value (Ze_);
a 2-9 step of receiving, by the account module, a request for the second ID (AA_ID) and blind signature along with the first ID (A_ID), the third token, the first zero encryption value (Ze_) and the fifth encryption value, from the user terminal;
a 2-10 step of carrying out, by the account module, hash to the second encryption value (AA_ID_) to generate a first hash value (h_AA_ID);
a 2-11 step of carrying out, by the account module, blind signature to the fifth encryption value;
a 2-12 step of carrying out, by the account module, electronic signature to a fourteenth value including the first hash value (h_AA_ID) to generate a fifth validity verification value;
a 2-13 step of transmitting, by the account module, the second encryption value (AA_ID_), the blind signature value, the fourteenth value, and the fifth validity verification value, to the user terminal;
a 2-14 step of obtaining, by the user terminal, a sixth validity verification value which is a validity verification value of the thirteenth value, from the blind signature value;
a 2-15 step of generating, by the user terminal, a second zero encryption value (Ze′_);
a 2-16 step of receiving, by the node module, a request for the user's identification information (BS) along with the subject identification information (v_id), the second encryption value (AA_ID_), the second zero encryption value (Ze′_), the fourteenth value and the fifth validity verification value, from the user terminal;
a 2-17 step of carrying out, by the node module, a fifth arithmetic operation to the second encryption value (AA_ID_) and the eleventh value (Cv) to generate a sixth encryption value (BS_);
a 2-18 step of transmitting, by the node module, a request for a second tag value (tag2) along with the sixth encryption value (BS_) and the second zero encryption value (Ze′_), to the repository module;
a 2-19 step of of carrying out, by the repository module, a sixth arithmetic operation to obtain a seventh encryption value (tag2_) which is a homomorphic encryption value of the second tag value (tag2), the sixth arithmetic operation being an operation where a value obtained by multiplying the sixth encryption value (BS_) and a 3-1 random value (R1), a 3-2 random value (R2) and a value obtained by multiplying a 3-3 random value (R3) and the second zero encryption value (Ze′_) are subtracted or added to one another;
a 2-20 step of receiving, by the node module, a seventh hash value which is a hash value of the 3-1 random value (R1) and the 3-2 random value (R2), the session ID (vs_id) and the seventh encryption value (tag2_), from the repository module;
a 2-21 step of transmitting, by the node module, the session ID (vs_id), the sixth encryption value (BS_), the seventh encryption value (tag2_) and the seventh hash value, to the user terminal;
a 2-22 step of receiving, by the node module, the session ID (vs_id), a fifteenth value (BS$) which is a value obtained by carrying out an arithmetic operation to the user's identification information, a sixteenth value which is a value obtained by carrying out an arithmetic operation to the second tag value, the seventh hash value, the subject identification information (v_id), the fifth hash value (bs), the opinion value (voting) and the sixth validity verification value, from the user terminal;
a 2-23 step of transmitting, by the node module, a request for verification of the fifteenth value (BS$) along with the fifteenth value (BS$), the sixteenth value (tag2$), the session ID (vs_id), the fourth value (G) and the fifth value (P), to the repository module;
a 2-24 step of verifying, by the node module, the 3-1 random value (R1) and the 3-2 random value (R2) by comparing the seventh value with the hash value of the 3-1 random value (R1) and the 3-2 random value (R2) received from the repository module; and
a 2-25 step of storing, by the node module, the opinion value (voting), the subject identification value (v_id), the fifth hash value (bs) and the sixth validity verification value if the verification of the value (BS$), the fifth hash value (bs) and the sixth validity verification value is successful.

12. A computer-implemented method of claim 11, wherein the fourteenth value further includes time information of the account module.

13. A computer-implemented method of claim 11, wherein the fourth arithmetic operation is “[the first random value (Re)*the second random value (Ra)+the first ID (A_ID)]*the eleventh value (Cv).”

14. A computer-implemented method of claim 13, wherein the value (BS$) derived from the subject identification information (BS) is the fourth value^{BS} (mod P).

15. A computer-implemented method of claim 14, wherein the fifth arithmetic operation is “the second encryption value (AA_ID)*the eleventh value (Cv).”

16. A computer-implemented method of claim 15, wherein the sixth arithmetic operation is “R1*BS_+R2+R3*Ze′_.

17. A computer-implemented method of claim 16, wherein the value (tag2$) derived from the second tag value is G^{tag2} (mod P).
